(19) United States
(12) Patent Application Publication
(10) Pub. No.: US 2017/0130922 A1
(43) Pub. Date: May 11, 2017

(54) JOINT BETWEEN HOUSING AND HEADLAMP OUTER LENS WITH GLUE-RETAINING RIBS

(71) Applicant: Valeo Vision, Bobigny Cedex (FR)

(72) Inventors: Mehdi Madelaine, Maze (FR); Steve Vincent, Becon Les Granits (FR); Thiery Rousselet, Angers (FR); Jean-Marc Gressot, Betton (FR)

(21) Appl. No.: 15/342,447

(22) Filed: Nov. 3, 2016

(30) Foreign Application Priority Data
Nov. 5, 2015 (FR) 1560629

(51) Int. Cl. F21S 8/10

(52) U.S. Cl. CPC F21S 48/1208; F21S 48/2206

(57) ABSTRACT

A housing for a lighting device, in particular for a motor vehicle, comprising a wall delimiting a cavity designed to receive one or more lighting modules, and an edge that delimits the cavity and is designed to be glued to a corresponding rim of an outer lens designed to cover the cavity. The edge has at least one portion with ribs that are designed to be in contact with the glue and are oriented such as to limit the flow of the glue during application of same. The invention also relates to a lighting device including the housing, and to a method for assembling the device.

### CROSS-REFERENCE TO RELATED APPLICATIONS

This application claims priority to the French application 1560629, filed Nov. 5, 2015, which application is incorporated herein by reference and made a part hereof.

### BACKGROUND OF THE INVENTION

1. Field of the Invention

The invention relates to the field of lighting devices, in particular luminous signaling and/or lighting devices for motor vehicles.

2. Description of the Related Art

Published patent document EP 0 187 593 A1 discloses a method for assembling a motor vehicle headlamp outer lens with the housing of same. The method involves gluing the rim of the outer lens to a corresponding edge of the housing, the profiles of the rim and of the edge forming an internal expansion volume for the glue within the contour of the assembled parts. This document has a priority date in 1984, at a time where headlamp outer lenses usually had geometric shapes with joining zones that were mostly flat or at least nearly flat. The glue could then be applied gradually along the edge of the housing when the edge was arranged horizontally without a significant risk of the glue flowing along the edge.

Published patent document U.S. Pat. No. 5,909,957 also discloses a method for assembling a motor vehicle headlamp outer lens to the housing of same. The edge of the housing has a slot at the bottom of which a urethane adhesive is applied. To do so, the housing is oriented with the cavity and opening of same oriented upwards. The outer lens is then placed on the housing such that the rim of same enters the slot and comes into contact with the adhesive. The rim includes points designed to pass through the adhesive and come into direct contact with the bottom of the slot, to be welded thereto using ultrasound.

Neither of the aforementioned two documents addresses the problem of applying the glue or the elastomer seal in liquid or paste form, in particular if the edge of the housing has significant variations in gradient. Indeed, if the edge has significant gradients in relation to the horizontal when the housing is oriented with the cavity and opening of same facing upwards, the paste or liquid applied along the edge is liable to flow, thereby accumulating in excess at certain points and leaving other points with insufficient coverage.

### SUMMARY OF THE INVENTION

The invention is intended to address at least one of the problems in the prior art, in this case the aforementioned prior art. More specifically, the invention is intended to facilitate the application of the glue or of the polymerizable liquid intended to provide the join and/or seal between the housing and the outer lens, in particular if the edge of the housing has variations in gradient in relation to the horizontal.

The invention relates to a housing for a lighting device, in particular a signaling and/or lighting device for a motor vehicle, comprising: a wall delimiting a cavity designed to receive one or more lighting modules, an edge that delimits the cavity and is designed to be glued to a corresponding rim of an outer lens designed to cover the cavity, that is noteworthy in that the edge has at least one portion with ribs that are designed to be in contact with the glue and are oriented such as to at least limit the flow of the glue during application of same.

“At least limit the flow of the glue” means limiting or eliminating the flow.

The glue is advantageously a polyurethane glue with activator. The glue may have a polymerization time of between 10 and 15 minutes. Such glue is in particular fluid before polymerization. Such glue may have a dynamic viscosity before polymerization of less than 185 Pa·s, and preferably less than 90 Pa·s.

The edge advantageously forms the end of the wall.

The adjacent ribs in the portion or each of the portions of the edge may be spaced apart from one another by a distance of between 1 mm and 30 mm, preferably between 5 mm and 20 mm.

The average thickness of the ribs may be between 0.5 mm and 3 mm. The maximum height of the ribs may be between 1 mm and 5 mm.

The portion or each of the portions with ribs may include at least three, and preferably at least five, and more preferably at least seven ribs.

According to an advantageous embodiment of the invention, the edge of the housing forms a slot with a bottom and two lateral faces. Advantageously, the ribs are arranged on the lateral face located on the side of the cavity.

According to an advantageous embodiment of the invention, the ribs extend as far as the bottom of the slot.

According to an advantageous embodiment of the invention, the height of the ribs increases towards the bottom of the slot.

According to an advantageous embodiment of the invention, the ribs are spaced apart from one another.

According to an advantageous embodiment of the invention, the ribs are substantially parallel to one another.

According to an advantageous embodiment of the invention, the ribs extend across the longitudinal direction of the corresponding portion of the edge. The longitudinal direction of the portion of the edge is the average longitudinal direction of the portion.

According to an advantageous embodiment of the invention, the housing includes an optical axis coinciding with a main luminous signaling and/or lighting direction, the portion or each of the portions with the ribs forming an angle with the optical axis that is less than 45°.

According to an advantageous embodiment of the invention, the angle formed by the portion or each of the portions with the optical axis is less than 40°.

According to an advantageous embodiment of the invention, the angle formed by the portion or each of the portions with the optical axis is less than 35°.

According to an advantageous embodiment of the invention, the optical axis coincides with the longitudinal axis of the vehicle. The longitudinal axis of the vehicle is the main axis of the vehicle oriented in the direction of straight-line movement of same.

According to an advantageous embodiment of the invention, the ribs form an angle with the optical axis that is less than 20°.

According to an advantageous embodiment of the invention, the angle formed between the ribs and the optical axis is less than 15°.

According to an advantageous embodiment of the invention, the angle formed between the ribs and the optical axis is less than 10°.

According to an advantageous embodiment of the invention, the housing includes a mold-removal axis, the portion or each of the portions with the ribs forming an angle with the axis that is less than 45°.

“Mold-removal axis” means the movement axis of the molding portions of the housing mold enabling the housing to be ejected from the mold. This mold-removal axis may double the width of the slot, resulting in increased flowing of the glue.

According to an advantageous embodiment of the invention, the angle formed by the portion or each of the portions with the mold-removal axis is less than 40°.

According to an advantageous embodiment of the invention, the angle formed by the portion or each of the portions with the mold-removal axis is less than 35°.

According to an advantageous embodiment of the invention, the ribs are parallel to the mold-removal axis.

According to an advantageous embodiment of the invention, the ribs are integral with the edge and the wall. “Integral with” means that the material forming the ribs is continuous with, and preferably identical to, the material forming the edge of the wall.

According to an advantageous embodiment of the invention, the housing is a motor vehicle headlamp housing, the portion or portions of the edge including ribs that are located on an upper rear portion of the edge when the housing is in the assembly position on the vehicle.

The invention also relates to a lighting device, in particular for a motor vehicle, comprising: a housing forming a cavity seating one or more lighting modules and including an edge delimiting the cavity, and an outer lens covering the cavity, with a rim glued to the edge of the housing, that is noteworthy in that the housing is as claimed in the invention, the glue being in contact with the ribs.

According to an advantageous embodiment of the invention, the rim of the outer lens has a mold-removal axis that forms an angle with a mold-removal axis of the slot in the housing, the angle being equal to or greater than 10°. This angle may be greater than 20°.

According to an advantageous embodiment of the invention, the width of the slot is greater than the thickness of the rim of the outer lens.

The invention also relates to a method for assembling a lighting device according to the invention, comprising the following steps: (a) positioning the housing such that the cavity is oriented upwards, (b) applying the glue along the edge of the housing, (c) positioning the outer lens with the rim of same along the edge of the housing and in contact with the glue.

According to an advantageous embodiment of the invention, step (b) is done by extrusion.

According to an advantageous embodiment of the invention, during step (b), the glue is applied last to the portion or portions of the edge that include the ribs.

The measures according to the invention are beneficial since they address, in a simple and cheap manner, the problem of the glue flowing during application of same to the portions of the edge that are particularly inclined in relation to the horizontal. Indeed, formation of the ribs according to the invention is particularly cheap since it does not require any special measures to be taken other than those required in relation to the manufacturing mold to form the ribs. According to a specific embodiment of the invention, the ribs are furthermore concealed by the outer lens.

These and other objects and advantages of the invention will be apparent from the following description, the accompanying drawings and the appended claims.

### BRIEF DESCRIPTION OF THE ACCOMPANYING DRAWINGS

Other features and advantages of the present invention are explained in greater detail in the description and the drawings, in which:

FIG. 1 is a perspective view of a headlamp housing according to the invention;

FIG. 2 is another perspective view of the housing in FIG. 1, in which the housing is oriented with the cavity and opening of same facing upwards; and

FIG. 3 is a detailed perspective view of the portion of the edge of the housing in FIGS. 1 and 2 including ribs.

### DETAILED DESCRIPTION OF THE PREFERRED EMBODIMENTS

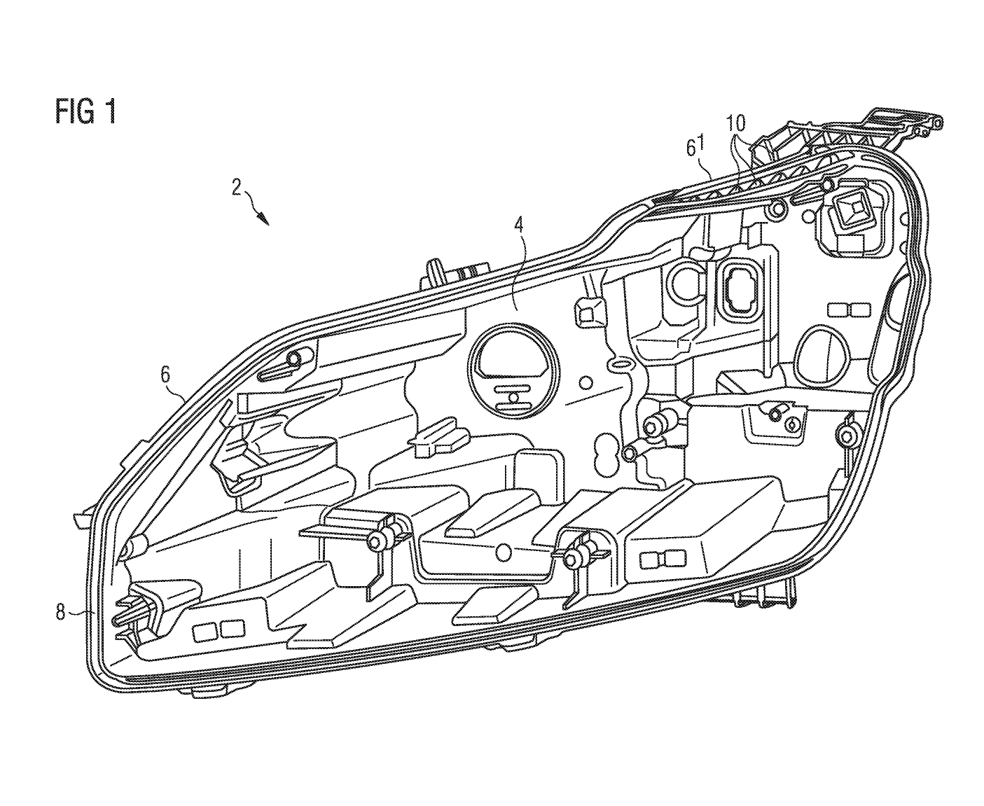

FIG. 1 shows a housing 2 for a lighting device, in this case a motor vehicle headlamp. Such a lighting device may perform different functions, in particular low-beam or high-beam lighting, or signaling functions such as direction indicators (flashers), side lights or daytime running lights (DRL).

The housing 2 includes a wall 4 that may have a complex shape. The wall 4 forms a cavity designed to receive one or more lighting modules (not shown) designed to perform one or more of the aforementioned functions. These modules are well known to the person skilled in the art.

The housing 2 also includes an edge 6 delimiting an opening of the cavity. This edge 6 is advantageously located on the wall 4, and more specifically at the end of the wall 4. The edge 6 advantageously forms a closed contour delimiting the opening of the cavity of the housing 2. The edge 6 is designed to cooperate with an outer lens in order to close the cavity. The outer lens is by definition transparent and may be made of glass or more advantageously of plastic. Such an outer lens is well known to the person skilled in the art. The edge 6 may advantageously form a slot 8 designed to receive a rim of the outer lens to be attached thereto by gluing.

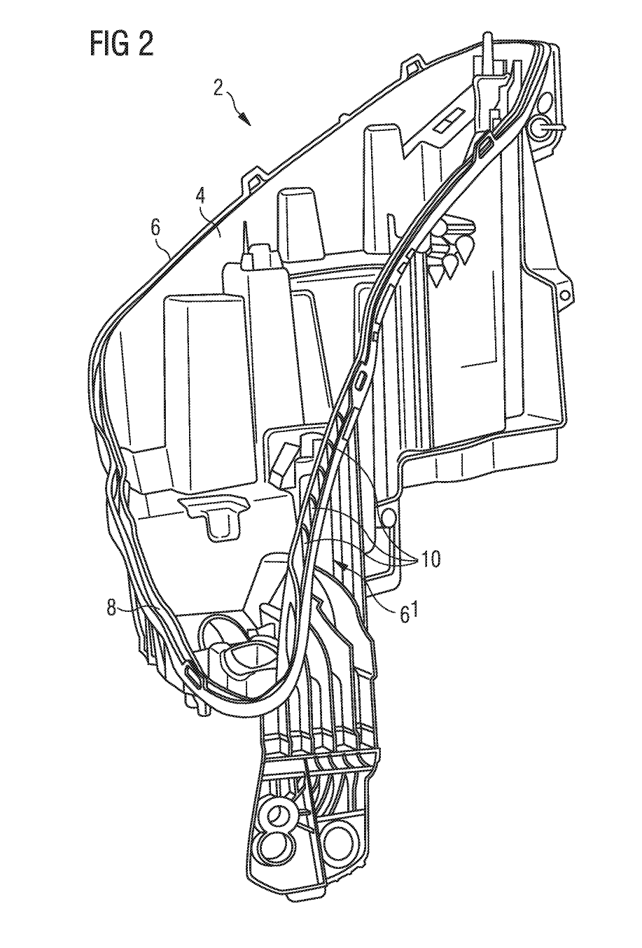

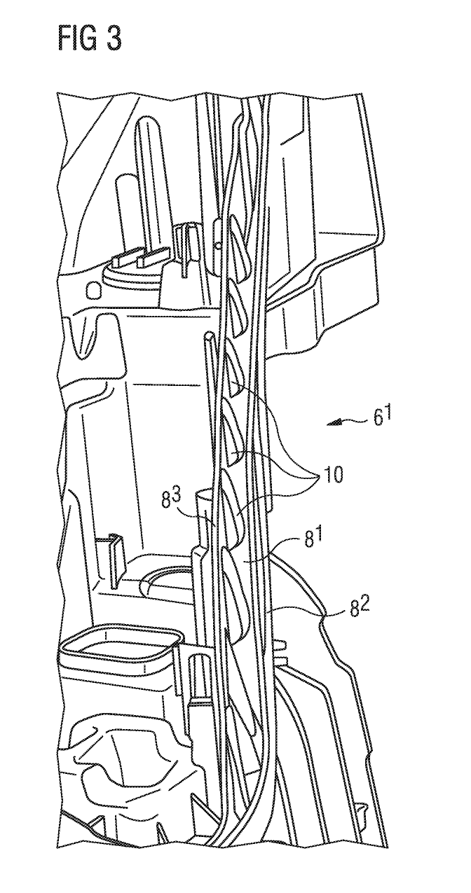

The edge 6 includes a portion 6¹ including ribs 10, and more specifically ribs inside the slot 8. The portion 6¹ of the edge 6 is located on a rear (in relation to the direction of forward movement of the vehicle when the headlamp is assembled on the vehicle) upper side zone of the housing 2. This portion 6¹ is shown in greater detail in FIGS. 2 and 3.

FIG. 2 shows the housing 2 in FIG. 1 in a position in which the cavity and opening of same are oriented upwards, and more precisely vertically. As shown, the portion 6¹ is sharply inclined in relation to the horizontal. More specifically, this portion 6¹ is the portion of the edge 6 that is most inclined in relation to the horizontal. The ribs 10 are designed and arranged to retain or at least limit the flow of the glue or any other pasty fluid used to assemble the outer lens, which is applied to the edge 6 in order to assemble the outer lens.

As shown in FIG. 2, the slots 8 are oriented along the longitudinal axis of the headlamp, which coincides with the optical axis of same and advantageously with the mold-removal direction of the housing 2. This latter is effectively advantageously made of plastic by injection into a mold with a movable portion. The movement of this latter enables the housing 2 to be removed from the mold.

The inclined portion 6¹ of the edge 6 may form an angle with the vertical, when the housing 2 is oriented with the cavity facing upwards in order to apply the glue, that is less than 45°, and preferably less than 40°, and more preferably less than 35°. It should be noted that, although a single portion 6¹ provided with ribs 10 is shown in the housing 2 illustrated, it is nonetheless possible for the housing 2 to have several inclined portions 6¹ provided with ribs 10.

The ribs 10 thus form barriers stopping the flow of the glue in liquid or pasty state. During assembly of the outer lens, the glue is in fact applied, preferably by extrusion, along the edge 6 while the housing 2 is in the position illustrated in FIG. 2. The outer lens is then positioned using a vertical downward movement to cause the rim of the outer lens to cooperate with the edge 6, and more specifically with the slot 8 in the edge 6 and with the glue applied thereto. The ribs 10 therefore hinder the viscous flow of the glue from the time the glue is applied to this portion 6¹ of the edge 6 and the time the rim of the outer lens comes into contact with the glue.

The glue is advantageously a polyurethane glue with activator. The glue may have a polymerization time of between 10 and 15 minutes. Such glue is in particular fluid before polymerization. Such glue may have a dynamic viscosity before polymerization of less than 20 Pa·s, and preferably 15 Pa·s, and more preferably 10 Pa·s.

FIG. 3 is a detailed view of the portion 6¹ of the edge, provided with slots 8. The slot 8 has a U-shaped section with a bottom 8¹ and two lateral faces or walls 8² and 8³. The ribs 10 are advantageously formed on the inner lateral face or wall 8³ such as to be concealed by the outer lens once the outer lens has been positioned. It is nonetheless understood that the ribs 10 may also be formed on the opposite face or wall 8², or on both lateral faces or walls 8² and 8³ alternately. It can also be seen that the height of the ribs 10 increases between the entrance of the slot 8 and the bottom 8¹ of the slot 8. This arrangement of the ribs 10 is beneficial in that it facilitates the positioning of the rim of the outer lens, and in that it ensures the effective retention of the glue in the bottom of the slot 8. The ribs 10 advantageously extend as far as the bottom 8¹ of the slot to form an integral part of the bottom 8¹.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A housing for a lighting device, in particular for a motor vehicle, comprising:
a wall delimiting a cavity designed to receive one or more lighting modules; and
an edge that delimits said cavity and is designed to be glued to a corresponding rim of an outer lens designed to cover said cavity;
wherein said edge has at least one portion with ribs that are designed to be in contact with a glue and are oriented such as to at least limit the flow of said glue during application of same.

2. The housing according to claim 1, wherein said edge of said housing forms a slot with a bottom and two lateral faces.

3. The housing according to claim 2, wherein said ribs extend as far as said bottom of said slot.

4. The housing according to claim 2, wherein a height of said ribs increases towards said bottom of said slot.

5. The housing according to claim 1, wherein said ribs extend across a longitudinal direction of said at least one portion of said edge.

6. The housing according to claim 1, wherein said housing includes an optical axis coinciding with a main luminous signaling and/or lighting direction, said at least one portion with said ribs forming an angle with said optical axis that is less than 45°.

7. The housing according to claim 6, wherein said optical axis coincides with a longitudinal axis of said motor vehicle.

8. The housing according to claim 6, wherein said ribs form an angle with said optical axis that is less than 20°.

9. The housing according to claim 1, wherein said housing includes a mold-removal axis, said at least one portion forming an angle with said mold-removal axis that is less than 45°.

10. The housing according to claim 9, wherein said ribs are parallel to said mold-removal axis.

11. The housing according to claim 1, wherein said housing is a motor vehicle headlamp housing, said at least one portion of said edge including said ribs that are located on an upper rear portion of said edge when said housing is in an assembly position on said motor vehicle.

12. A lighting device for a motor vehicle, comprising:
a housing forming a cavity seating one or more lighting modules and including an edge delimiting said cavity; and
an outer lens covering said cavity, with a rim glued to an edge of said housing;
wherein said housing is as claimed in claim 1, a glue being in contact with said ribs.

13. The lighting device according to claim 12, wherein siad edge of said housing forms a slot with a bottom and two lateral faces, and said rim of said outer lens has a mold-removal axis that forms an angle with a mold-removal axis of said slot in said housing, said angle being equal to or greater than 10°.

14. The lighting device according to claim 13, wherein said slot is wider than a thickness of said rim of said outer lens.

15. A method for assembling a lighting device according to claim 12, said method comprising the following steps:
positioning said housing such that said cavity is oriented upwards;
applying a glue along said edge of siad housing; and
positioning said outer lens with siad rim of same along said edge of said housing and in contact with said glue.

16. The housing according to claim 3, wherein a height of said ribs increases towards said bottom of said slot.

17. The housing according to claim 2, wherein said ribs extend across a longitudinal direction of said at least one portion of said edge.

18. The housing according to claim 2, wherein said housing includes an optical axis coinciding with a main luminous signaling and/or lighting direction, said at least one portion with said ribs forming an angle with said optical axis that is less than 45°.

19. The housing according to claim 7, wherein said ribs form an angle with said optical axis that is less than 20°.

20. The housing according to claim 2, wherein said housing includes a mold-removal axis, said at least one portion forming an angle with said mold-removal axis that is less than 45°.
